(19) United States
(12) Patent Application Publication
(10) Pub. No.: US 2023/0094974 A1
(43) Pub. Date: Mar. 30, 2023

(54) SYSTEM AND PROCESS FOR MAKING SHAPED MEAT PRODUCTS REFERENCE TO RELATED APPLICATIONS

(71) Applicant: James Lesslie, Las Vegas, NV (US)

(72) Inventor: James Lesslie, Las Vegas, NV (US)

(21) Appl. No.: 18/076,875

(22) Filed: Dec. 7, 2022

Related U.S. Application Data
(63) Continuation-in-part of application No. 17/089,718, filed on Nov. 4, 2020.

(51) Int. Cl. A23L 13/60; A23L 13/75; A23L 13/76; A22C 17/00

(52) U.S. Cl. CPC A23L 13/67; A23L 13/75; A23L 13/62; A23L 13/76; A22C 17/002

(57) ABSTRACT

A system and a process for preparing a shaped-meat product are disclosed. The system includes an oven, a rack insertable into the oven, and apertured tubes onto which strips of meat are spirally wound. The tubes are arranged horizontally in the oven. The strips of meat are cooked and dehydrated using heated air for 3 to 4½ hours at a temperature ranging about 135 to 170° F.

### REFERENCE TO RELATED APPLICATIONS

This patent application is a continuation-in-part (“CIP”) of U.S. patent application Ser. No. 17/089,718 filed Nov. 4, 2020, which claims priority to US design application Serial No. 29/723,611 filed Feb. 7, 2020, and to U.S. provisional application Ser. No. 62/930,470 filed Nov. 4, 2019—all of which are hereby incorporated by reference in their entirety.

### FIELD

The present subject matter, in general, is directed to a system and process for making certain food products and, more particularly, is directed to a system and process for making helical-shaped meat products having a distinct spongy, chewy texture, stylized spiral shape, and with a flavor and taste that is unique in a minimum amount of time without complex machinery.

### BACKGROUND

Dried or dehydrated meat products, referred to as “jerky products” are a popular snack food and gift item. The popularity of jerky products among certain consumers has so increased over time that jerky products, shipped overseas, are marketed in Europe and such countries as Canada and Japan.

Various methods for producing meat jerky products are known. For instance, in US published application 2017/0027202 to Timberlake, meat jerky is prepared as follows. A whole slab of raw meat is sliced into multiple whole, single slices. Then, a marinade is prepared from dark brown sugar, liquid smoke, Worcestershire sauce, clover honey, hot sauce, and teriyaki sauce. Next, the whole, single meat slices are marinated for a predetermined amount of time and temperature in a refrigerator, during which time the marinated whole, single slices of meat are flavored with one of multiple flavoring agents, for example, black pepper, cayenne pepper, jalapeno pepper, sriracha, lemon pepper, garlic, herbs, a barbeque spice blend powder, and so forth, to obtain an associated corresponding flavoring agent flavor. Next, the marinated and flavored whole, single slices of meat are cooked in an oven at a predetermined temperature for a predetermined amount of time. The cooked whole, single slices of meat are lastly allowed to cool to room temperature for producing whole, single slices of meat jerky.

US published application 2019/0021376 to Cappozzo et al. discloses meat jerky or sausage having a higher protein content than traditional meat jerky and sausage products that claim to maintain the same or similar texture and taste. Disclosed are compositions of meat snacks, jerky, jerky sausage, or similar products which include dehydrated meat powders or broth powder.

US published application 2006/0035006 to McMindes et al. discloses a process for preparing a restructured meat product by combining a soy protein material, comminuted meat, and water. The disclosure asserts that a restructured meat product having a texture of intact muscle can be obtained. The soy protein material may further contain starch, flour, and fiber. The term “comminuted meat” refers to meat paste recovered from an animal carcass.

US published application 2002/0178928 to Hunter discloses a method and apparatus for distributing residual flavor from herbs and aromatics into the interior of meat for seasoning prior to and during cooking. The apparatus includes a reservoir for holding the aromatics in the form of a tapered, split, meat-piercing rod inserted into meat containing a predetermined quantity of aromatic and/or herb. After reaching a predetermine depth, the rod remains inserted during a cooking or marinating process. The rod, removed prior to the consumption of the meat, leaves behind the residual flavor from the rod.

US published application 2017/0223974 to Bauer discloses a method for preparing meat slices to maximize amount of meat used to produce, e.g., bacon, turkey bacon, beef bacon, jerky, and so forth. Meat portions are cut in a spiral pattern, to produce elongated strips. A spiral pattern comprises a curve on a plane coincident with a substantially planar meat surface portion.

In a known, conventional method, jerky products are prepared from ground meat as follows. Meat is first ground to a desired consistency. Then, blended with select ingredients, e.g., preservatives, curing agents, binding agents, and various flavoring agents, combined with the ground meat, to enhance the taste of a jerky meat product. The ground and blended mixture is cured for a predetermined amount of time and next solidified by freezing for a predetermined amount of time, to produce a meat loaf that can be cut into slices. The meat slices are dried or dehydrated in a drying chamber or dehydrator, and in some cases, dehydration is performed by heating in oil or fat in a vacuum to produce various edible jerky products. This method is time consuming since it requires a freezing step to solidify meat dough into a loaf.

In another conventional method, a rotary molder is used to produce jerky products. By this method, extruded meat dough is produced by blending ground meat components with select preservatives, curing agents, and flavoring agents. Extruded meat dough fed to the rotary molder produces meat pieces in a desired shape, which are dried or dehydrated to produce edible jerky products. Slicing the extruded meat dough typically requires the meat dough to be in a solid state, which may be achieved by chilling or freezing the dough. Although this method facilitates accurate slicing of the meat dough, the texture of jerky product produced may be undesirable since the product crumbles easily or results in products that look machine-made.

After reviewing prior art and conventional methods, I have concluded there is long felt need for a process for preparing whole, single strips of jerky having a distinct spongy, chewier texture, and stylized shape with a unique flavor and taste, made in a lesser amount of time without complex machinery.

### SUMMARY

A system for preparing shaped-meat products, according to principles of the present subject matter shall now be summarized. The system includes an oven having a cooking region or compartment. The system includes a rack insertable into and retractable from the cooking region or compartment.

The rack has opposite sides. Each side includes several shelf guides. Spaced along each shelf guide are U-shaped components called “saddles.” The saddles are dimensioned and configured to support apertured tubes horizontally in the cooking compartment. Meat strips, each about ¾ inches wide, about 14 inches long, and about ¼ inches thick, are spirally wrapped around tubes. Tubes bearing spirally wrapped meat strips are arranged horizontally in the cooking chamber by a feature that enables each tube to engage saddles on shelf guides of the cooking compartment opposite sides.

### BRIEF DESCRIPTION OF THE FIGURES

FIG. 1 is a schematic view depicting select components of the system and illustrating two of the steps of the process of the present subject matter.

FIG. 2 illustrates relative amounts of seasoning emulsion ingredients.

FIG. 3 is a flow diagram showing process steps relating to FIGS. 4-11.

FIG. 4 and FIG. 5 are flowcharts, together showing a procedure for marinating the meat slab in the seasoning emulsion, before slicing into strips.

FIG. 6 and FIG. 7 are flowcharts illustrating another process of the present subject matter, together showing a procedure for slicing the meat slab into meat strips, and then marinating the strips in a seasoning emulsion.

FIG. 8 is a flowchart of a process for preparing the emulsion of seasonings in accordance with embodiments of the present subject matter.

FIG. 9 is a flowchart of a process for heating meat strips of the present subject matter, by stepwise increasing the temperature, before dehydrating.

FIG. 10 is a flowchart of a process for using components of a system of the present subject matter, to produce spiral-shaped meat strip products.

FIG. 11 is a flowchart of a process for providing a plurality of bins and thereafter distributing the spiral-shaped meat strip products in the plural bins.

FIG. 12 is a front elevational, perspective view of an embodiment of yet another system which embodies principles of the present subject matter.

FIG. 13 depicts a front elevational, perspective view of a component of the embodiment of the present subject matter, which is shown in FIG. 12.

FIG. 14, a perspective view (on an enlarged scale relative to FIG. 12) depicts another component of the present subject matter. FIG. 14A presents a version of the FIG. 14 component, in relation to yet another component (shown in FIG. 15) of the FIG. 12 embodiment of the present subject matter.

FIG. 15, a perspective view on an enlarged scale relative to FIG. 12, depicts another component of the embodiment of the present subject matter.

FIG. 16 presents enlarged details of the component shown in FIG. 15.

FIG. 17 is a bowl, in perspective, filled with a plurality of spiral-shaped spiral-coiled meat products, made by a system of the present subject matter.

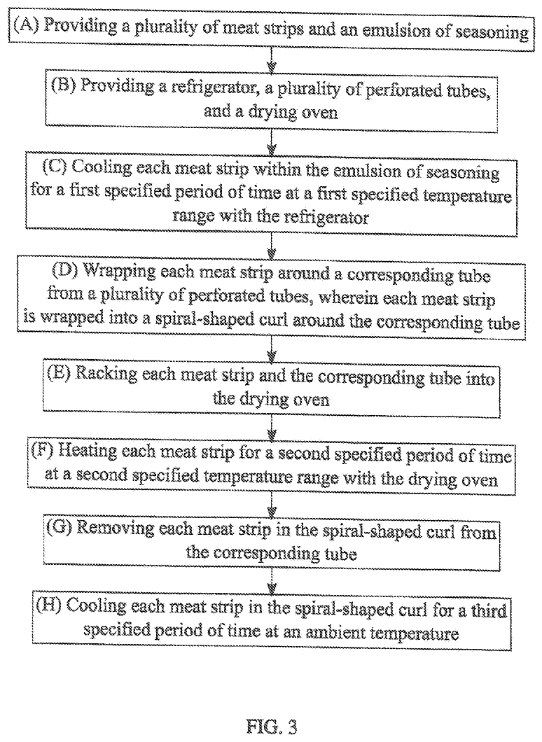

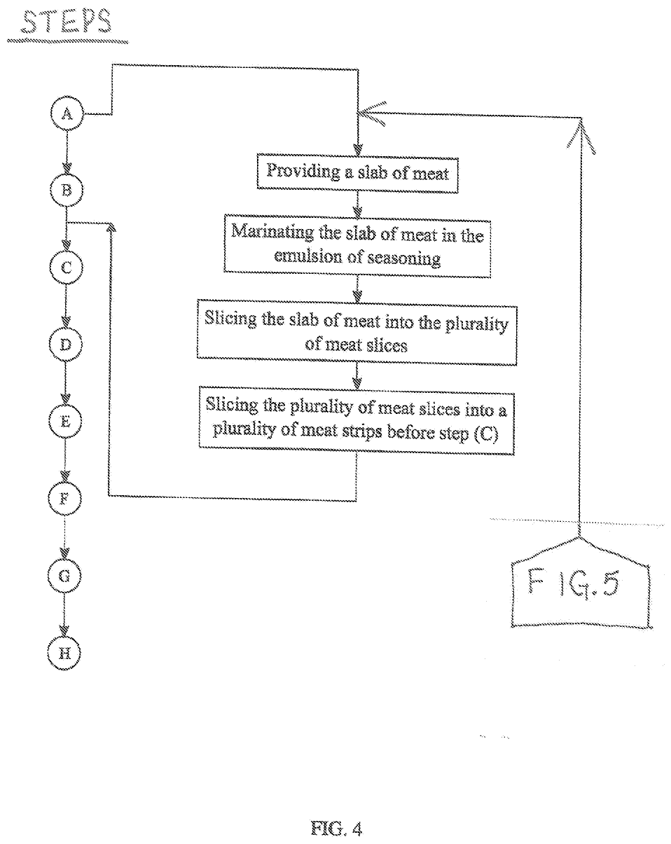

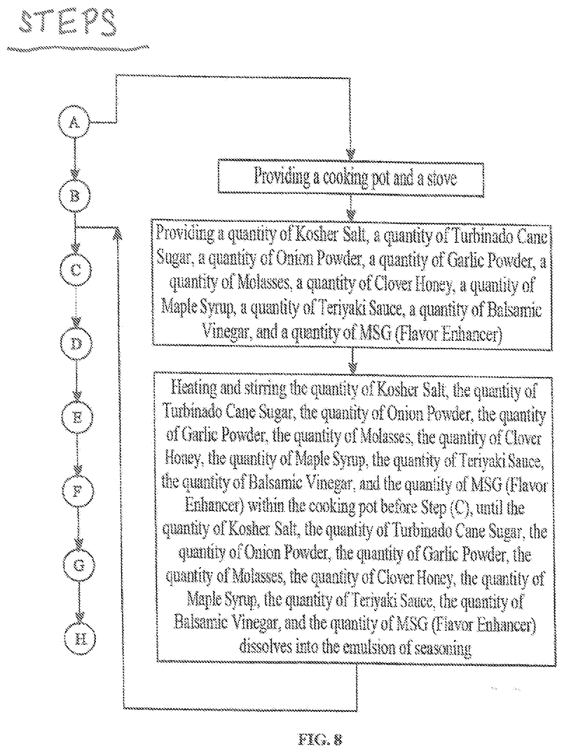

Steps listed in each of FIGS. 4, 6, and 8-11 are described in FIG. 3.

Throughout the figures and detailed description, related components of the present subject matter are identified by similar reference numerals.

### DETAILED DESCRIPTION

The purpose of the accompanying Figures is not to limit the scope of the claims, but rather to enable a person of ordinary skill in the art (“POSITA”) to better understand the detailed description of the present subject matter.

The present subject matter is directed to a system and process for manufacturing a spiral-shaped, essentially meat-based product which I shall refer to as spiral-coiled meat products throughout this patent specification. The process of the present subject matter produces coiled meat strips having a distinctive spongy, chewy-textured, mouthfeel and aromatic taste, with the strips being visually characterized as having a spiral- or helical-coiled shape.

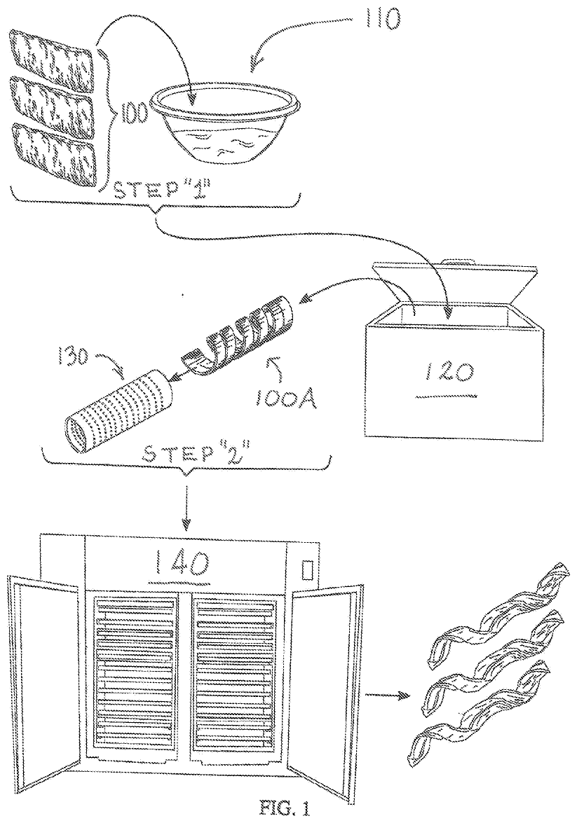

To provide my coiled meat strips with its distinctive spiral shape, the process of the present subject matter begins by combining a plurality of meat strips 100 with an emulsion of seasoning 110 (Step “1”), as shown in FIG. 1. While the plural meat strips 100 are preferably beef, substituting meat strips of venison, turkey, rabbit, pork, lamb, goat, chicken, bison, and so forth, would all be within the scope of the present subject matter. The emulsion of seasoning serves as a sort of marinade for the plural meat strips 100 and thereby serves to provide my coiled meat product with its distinctive taste.

After the plural meat strips 100 and emulsion of seasoning 110 are combined, they are stored in a refrigerator 120 for a predetermined amount of time, to enable the emulsion of seasoning “to flavor” the plural meat strips.

From refrigerator 120, meat strips 100A are coiled on a perforated tube 130. Several perforated tubes 130, each with meat strips 100A coiled around it, are hung in a drying oven 140 (Step “2”). The refrigerator 120 cools the coiled meat strips until they are ready to be cooked. For each tube 130, its outer diameter and perforation pattern, provides each meat strip curled around it with a distinctive spiral-shaped curl. In embodiments, the plural perforated tubes 130 are preferably made of electro-polished stainless steel including but not limited to 304, 304L, 316, and 316L grades of stainless steel. An outer diameter for perforated tubes 130 is preferably 0.629 inches and has perforation pattern dimensions for each perforated tube as being preferably 5/32-inch inner or hole diameter by 3/16-inch staggered centers.

The drying oven 140 cooks the plural meat strips marinated in the seasoning emulsion. While an AMISH electric drying oven is preferred, any type of electric drying oven is within the scope of the present subject matter.

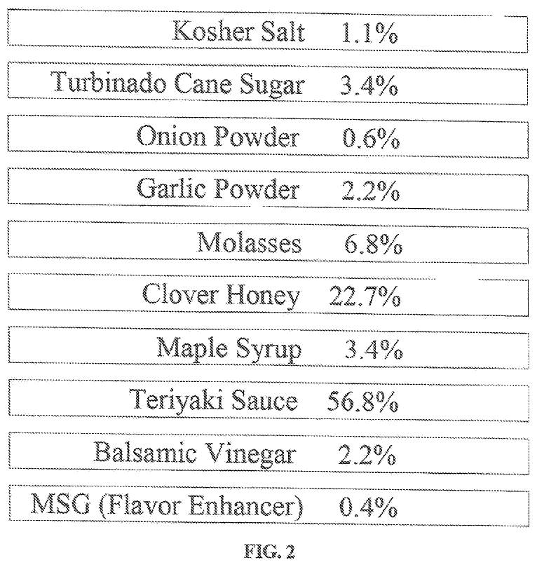

In embodiments, relative amounts of a seasoning emulsion include an ingredient mixture consisting essentially of 56.8 weight-percent (wt.-%) teriyaki sauce, 22.7 wt.-% clover honey, 6.8 wt.-% molasses, 3.4 wt.-% maple syrup, 3.4 wt.-% turbinado cane sugar, 2.2 wt.-% balsamic vinegar, 2.2 wt.-% garlic powder, 1.1 wt.-% kosher salt, 0.6 wt.-% onion powder, and 0.4 wt.-% MSG (monosodium glutamate) as a flavor enhancer (FIG. 2).

Commercial manufacture of coiled meat products of the present subject matter involves procedures believed to include at least the following.

The manufacture of coiled meat products of the present subject matter, requires that a plurality of meat strips and an emulsion of seasonings be provided. (In FIG. 3, please see Step “A”.) In addition, a refrigerator, a plurality of perforated tubes, and a drying oven must also be provided. (In FIG. 3, please see Step “B”.) Each meat strip in the emulsion is then cooled in the refrigerator at a predetermined temperature range for an amount of time (e.g., about 24 hours) which I prefer when marinating meat strips in an emulsion of seasonings (in FIG. 3, see Step “C”), to thereby provide the meat strips of the present subject matter with a distinctive flavor, mouthfeel, and taste. A preferred temperature range is between 36-40 degrees Fahrenheit.

Upon completion of marination, each meat strip is coiled around one of the perforated tubes, with the meat strips coiled around tubes becoming, in time, spiral-shaped meat products of the present subject matter (Step “D”).

Next, all the plural perforated tubes (each along with its several meat strips wrapped spirally around it) are hung from separate racks (“are racked”) in the drying oven (FIG. 3, see step “E”), and heated to a temperature ranging between about 135 to 170 degrees Fahrenheit for another predetermined amount of time, e.g., about 3 to 4½ hours. (In FIG. 3, please see Step “F”.)

After being dried, the spirally curled meat strips are separated from their associated perforated tubes (FIG. 3, see Step “G”), preferably held at ambient temperature (i.e., about 77 degrees Fahrenheit) for a predetermined period of time, e.g., about 24 hours (FIG. 3, see Step “H”) which allows for the concentration of honey, maple syrup, and molasses that migrated to the inner portions of each of the spirally curled meat strips, during the heating and dehydration process, to eventually diffuse uniformly through the meat, outwardly from the moist center to the drier surface, as the spirally curled meat strips cool-off, ultimately giving the spirally-coiled products a glazed and tasty appearance, after which time each coiled meat strip can be sliced, packaged, transported, distributed, and sold to consumers for consumption.

When beginning with a slab of meat, embodiments of processes of the present subject matter can process that slab of meat in at least two ways.

In accordance with one such process of the present subject matter, a slab of meat is marinated in an emulsion of seasonings. The slab of meat, after being marinated, is sliced into plural meat slices, and the meat slices are next sliced into meat strips, to provide a plurality of smaller and thinner portions of meat before step “C”. (Please refer to FIGS. 3 and 4.) A width of each strip is preferably about ¾ inch, and a thickness of each is preferably about 0.25 inches. Prior to marinating the slab of meat, a freezer is provided to store the slab of meat, preferably at a temperature of about 32 degrees Fahrenheit, for a predetermined amount of time. (Please refer to FIGS. 4, 5.)

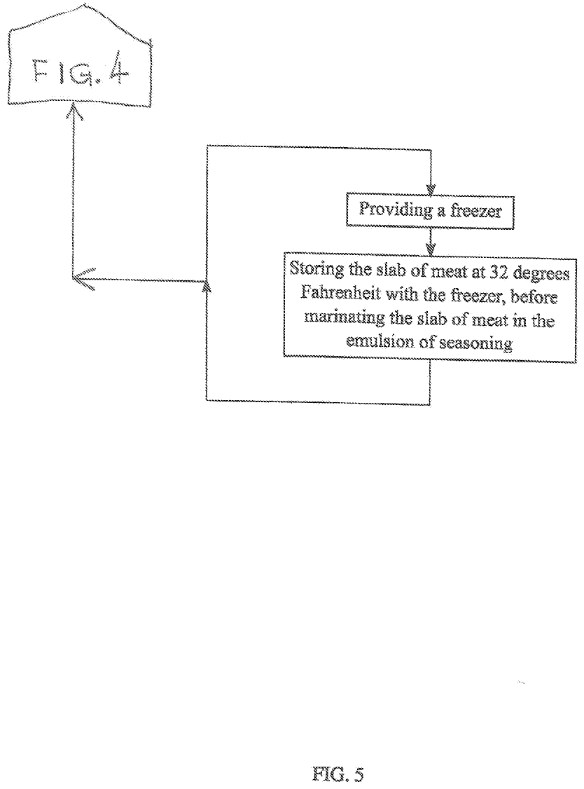

In accordance with another process of the present subject matter, the slab of meat starts off by being sliced into a plurality of meat slices, and the plurality of meat slices is then sliced into a plurality of meat strips. In this embodiment of the present invention, each of the plural meat strips is sealed with flavor (where a slab of meat would not be) since the plural meat strips are marinated in the emulsion of seasonings before step “C”. (Please refer to FIGS. 3 and 6.) By this process of the present subject matter, each meat strip is placed into a container of seasoning emulsion, one at a time, and then stirred with the emulsion-of-seasoning, until each meat strip is evenly coated. Width of a meat strip is preferably about ¾ inch, and the thickness of each is preferably about ¼ inch. Prior to slicing the slab of meat into these plural meat strips, a freezer is used to keep slabs of meat at about 32 degrees Fahrenheit (see FIGS. 6 and 7) for a predetermined amount of time.

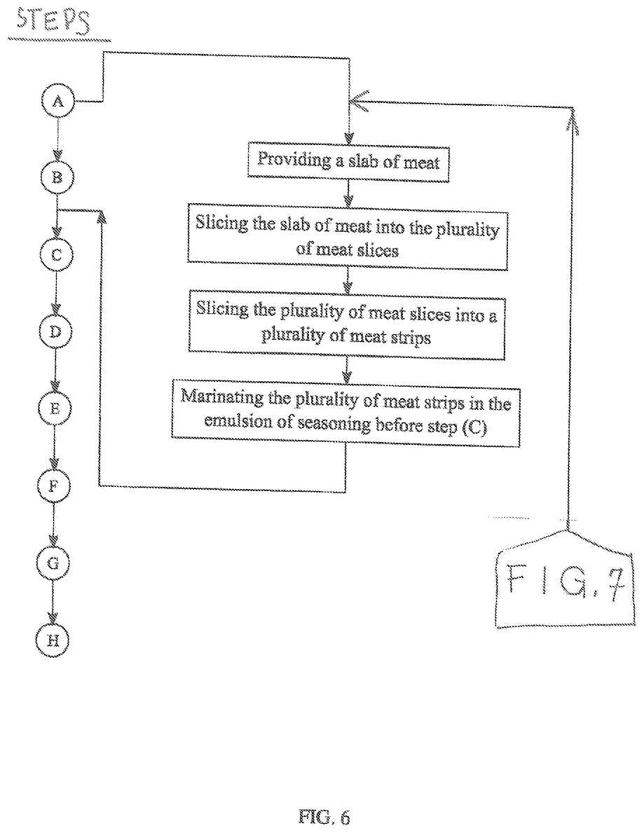

An illustrative system used to prepare the emulsion of seasonings in accordance with embodiments of the present subject matter requires a cooking pot and stove or their functional equivalents. (Please see FIG. 8.) Weighed amounts of kosher salt, turbinado cane sugar, onion powder, garlic powder, molasses, clover honey, maple syrup, teriyaki sauce, balsamic vinegar, and monosodium glutamate (MSG flavor enhancer) are selected as ingredients for the emulsion of seasonings. Kosher salt also enhances flavor of the emulsion-of-seasonings. In the preferred embodiment, the amount of kosher salt is approximately 1.49% by weight of the emulsion of seasonings. The relative amounts (FIG. 2) of turbinado cane sugar, molasses, clover honey and maple syrup (totaled together) sweeten the seasonings emulsion. In addition, the clover honey not only imparts a distinctive flavor into the meat strips but also facilitates removal of each spiral-shaped meat strip from its associated perforated tube. In a preferred embodiment of the seasoning emulsion, approximate weight percentages of ingredients are presented in FIG. 2. To prepare an emulsion-of-seasonings, kosher salt, turbinado cane sugar, onion powder, garlic powder, molasses, clover honey, maple syrup, teriyaki sauce, balsamic vinegar, and MSG (flavor enhancer) are provided in the cooking pot, heated, and stirred within the cooking pot before step “C”, until the kosher salt, turbinado cane sugar, onion powder, garlic powder, molasses, clover honey, maple syrup, teriyaki sauce, balsamic vinegar, and MSG dissolve into (or otherwise become a part of) the seasonings emulsion. The heating, stirring, and combining of the several ingredients recited above serves to concentrate and intensify the flavor or the emulsion-of-seasoning.

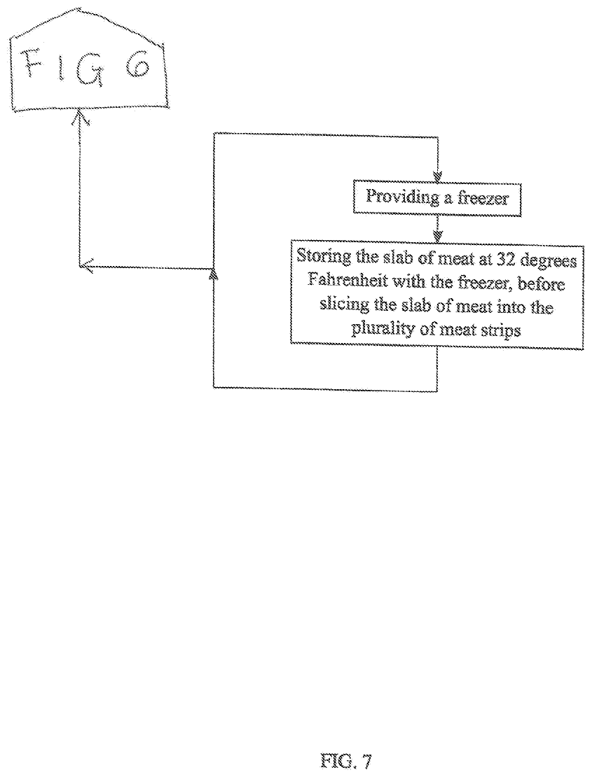

In order to evenly cook each meat strip for a spongy and chewy texture, each meat strip is heated for 30 minutes at 135 degrees Fahrenheit within the drying oven (see FIG. 9). Each meat strip is thereafter heated for 30 minutes at 150 degrees Fahrenheit within the drying oven. Each meat strip is thereafter heated for 30 minutes at 160 degrees Fahrenheit within the drying oven. Each meat strip is finally heated for 30 minutes at 170 degrees Fahrenheit within the drying oven. Each meat strip is thereafter dehydrated for 1 to 2½ hours at 155 degrees Fahrenheit within the drying oven during Step F. With each heating step, flavor within each meat strip is further sealed.

To progressively and thoroughly heat each meat strip, a plurality of spaced-apart saddles and an associated plurality of elongated foraminous tubes are used. Each elongated tube, having perforations formed as small openings arranged longitudinally, is removably secured to a spaced-apart pair of saddles. Each elongated tube-and-saddle-pair assembly is removably secured to an individual roll-up rack. In operation, several roll-up racks are provided in the drying oven, for progressively and thoroughly heating each meat strip that is helically (or spirally) wound around its associated elongated foraminous tube. Several roll-up racks are used to organize and position the plural spaced-apart pairs of saddles and elongated tubes in the drying oven.

A plurality of perforated tubes is preferably spaced one inch apart by the plurality of saddles; and, to evenly cook each meat strip, each perforated tube is engaged with a corresponding one of the plural saddles before Step E. The roll-up racks are placed inside of the drying oven, during Step E, in a way that stabilizes and offsets their saddles from each other. Each perforated tube is disengaged from its associated saddle, during Step G, for facilitating removal of each meat strip, with spiral-shaped curl, from its associated tube.

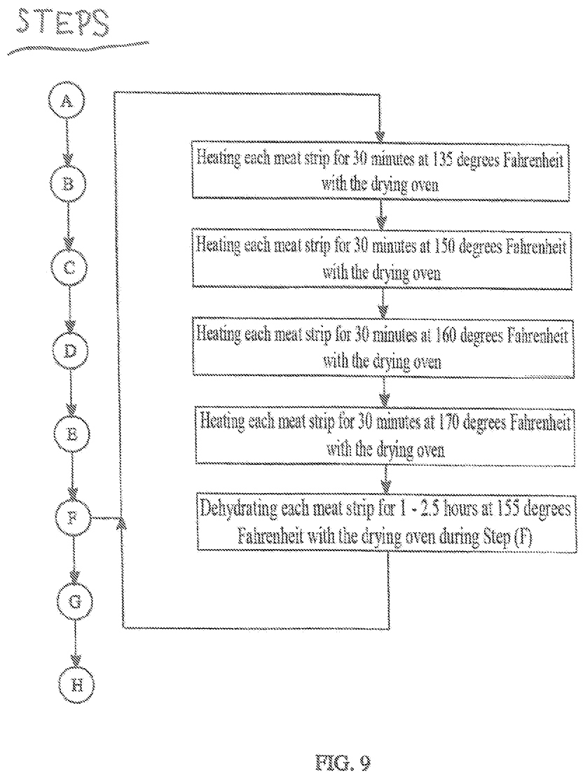

To protect the plural coiled meat products, thus produced, a plurality of bins (FIG. 11) is provided. Each of the plural coiled meat strips is first progressively and thoroughly cooked, and thereafter thoroughly and evenly cooled before the coiled meat products produced are distributed to the plural bins (Step “H”). In embodiments of the present subject matter, the fourteen (14) inch-long, spiral-shaped, meat-based strips produced are sliced into six (6) or seven (7) equal portions, each approximately two (2) inches in length, and prepped for vacuum-sealed packaging using vacuum sealing machines.

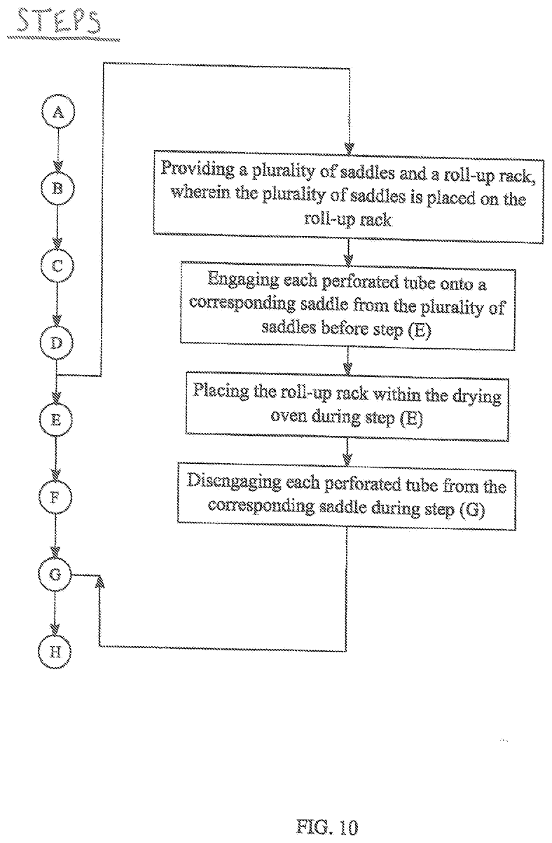

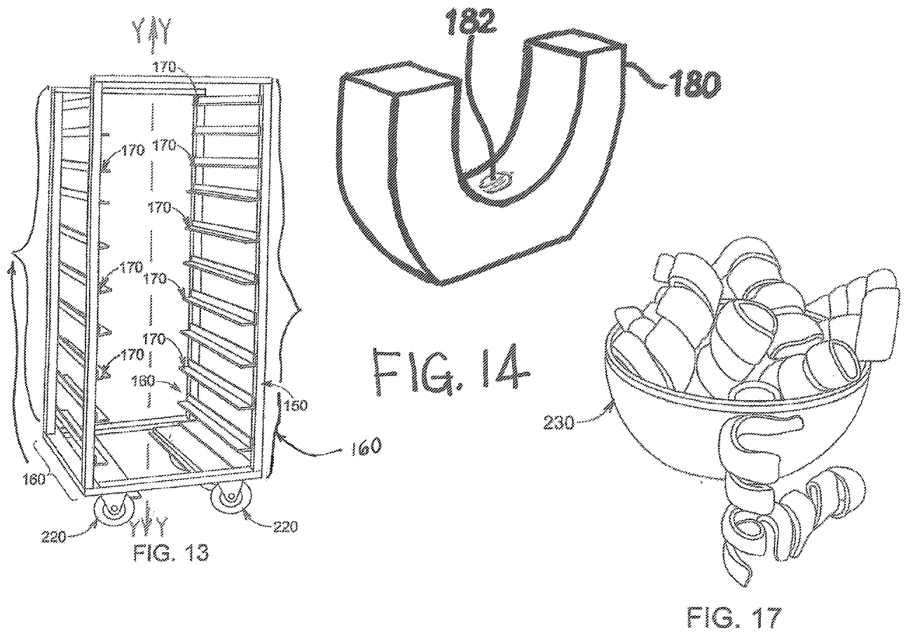

Referring next to FIGS. 12-16, another embodiment of a system for preparing a shaped-meat product according to principles of the present subject matter shall be described. This system includes another oven 140a defining a cooking region (C.R.) or compartment. This system also includes a rack 150 reciprocally movable along a first or horizontal axis X-X, for insertion into and retraction from the cooking region C.R. The rack 150 has opposite sides 160. Each of the opposite sides 160 includes a plurality of shelf guides 170. The shelf guides 170 are spaced apart along a second or vertical axis Y-Y which is oriented transverse to the horizontal axis X-X.

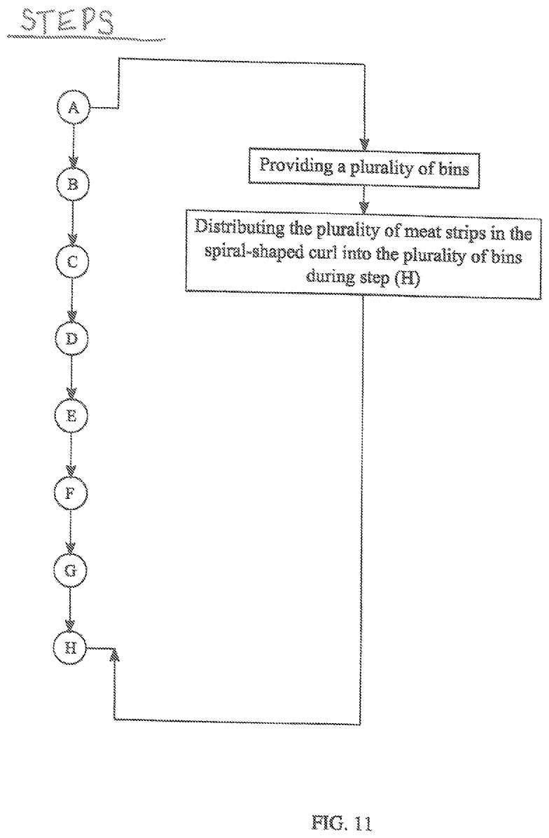

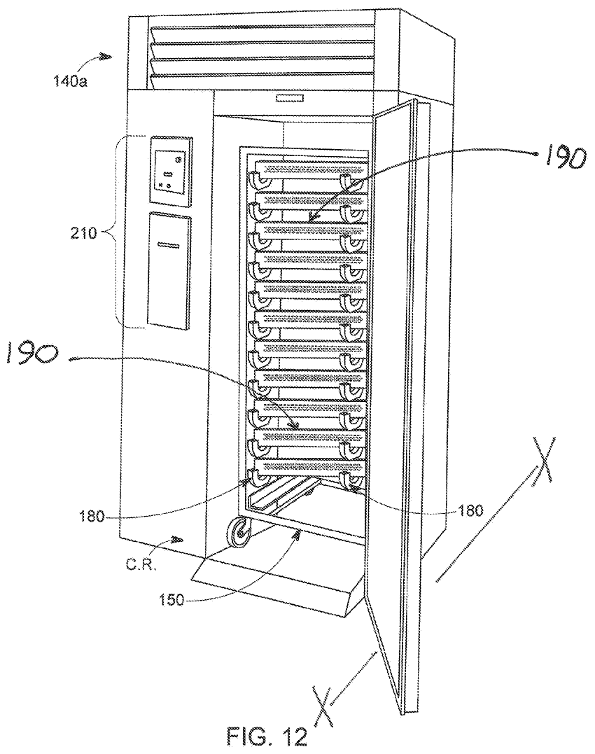

This system includes a plurality of U-shaped “saddles” 180 (FIG. 14) spaced apart from each other along the horizontal axis X-X (FIG. 12). The saddles 180 are also spaced apart along the vertical axis Y-Y (FIG. 13), along the length of each shelf guide 170 on both sides 160 of the rack 150. This system includes a plurality of apertured curling tubes 190. Each tube 190 (FIG. 14A) is dimensioned and configured for enabling a plurality of meat strips to be helically (or spirally) wrapped around it. (See, e.g., step “2” of FIG. 1.) In embodiments, each meat strip is about ¾ inches wide, about 14 inches long, and about ¼ inches thick; and each of the plural tubes 190 is supported at both of its opposite ends by a spaced-apart pair of saddles 180.

In embodiments, each saddle 180 (please refer to FIG. 14A) includes an extension (called a stabilizer pin) 182 and each curling tube 190 includes a depression 192 (called a stabilizer slot) at its opposite end portions. The depressions (characterized as rectangular slots) 192 are dimensioned and configured to receive and removably engage an associated one of the saddle extensions (rectangular stabilizer pins) 182, for removably securing each of the curling tubes 190 to their associated spaced-apart pair of saddles 180.

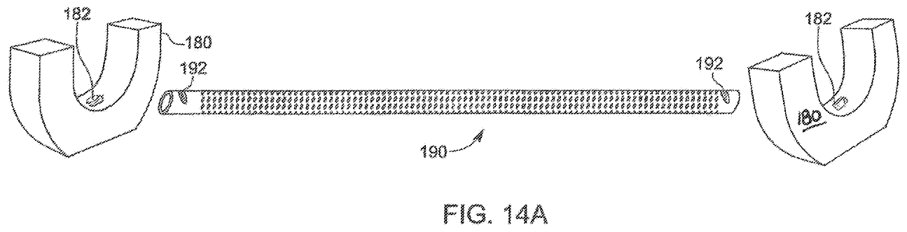

Each curling tube 190 has an outside diameter of about 0.629 inches, a patterned hole size of about 5/32 inches, a distance between hole centers of about 3/16 inches, and an open area of about 63%, as represented within a region identified by the reference numeral 200 in FIG. 16. In embodiments, the curling tubes 190 are electro-plated, 22-gauge, polished stainless steel.

The oven 140a of this embodiment includes a control panel 210 for enabling heating the cooking region to a temperature ranging from about 135 to about 170° F. for an amount of time ranging from about 3 to about 4½ hours. The rack 150 includes a wheel 220 at each underside corner portion for wheeling the rack 150 into and out of the cooking region or compartment.

Further in accord with principles of the present subject matter, another process for preparing a shaped-meat product includes the following steps: preparing a cooking ingredient mixture consisting essentially of about 1.1 weight-percent (wt.-%) kosher salt, about 3.4 wt.-% turbinado cane sugar, about 0.6 wt.-% onion powder, about 2.2 wt.-% garlic powder, about 6.8 wt.-% molasses, about 22.7 wt.-% clover honey, about 3.4 wt.-% maple syrup, about 56.8 wt.-% teriyaki sauce, about 2.2 wt.-% balsamic vinegar, and about 0.4 wt.-% monosodium glutamate; immersing a plurality of meat strips in the mixture for about 44 hours at a temperature ranging from about 36 to about 40 degrees Fahrenheit (° F.) to produce a plurality of seasoned meat strips, wherein each of the plural meat strips is about ¾ inches wide and about 14 inches long and about ¼ inches thick; spirally wrapping the plurality of seasoned meat strips around an associated plurality of apertured tubes 190, each tube 190 (see FIGS. 14A, 15, and 16) having an outside diameter of about 0.629 inches, a patterned hole size of about 5/32 inches, a distance between hole centers of about 3/16 inches, and an open area of about 63%; moving all the apertured tubes 190 having seasoned strips spirally wrapped therearound into the oven 140a (see FIG. 12) having a cooking region; and introducing into the cooking region a predetermined amount of heated air for about 3 to about 4½ hours at a temperature ranging from about 135 to about 170° F. for cooking and dehydrating the plural seasoned strips, thereby producing a plurality of meat products having an open-coiled spiral shape.

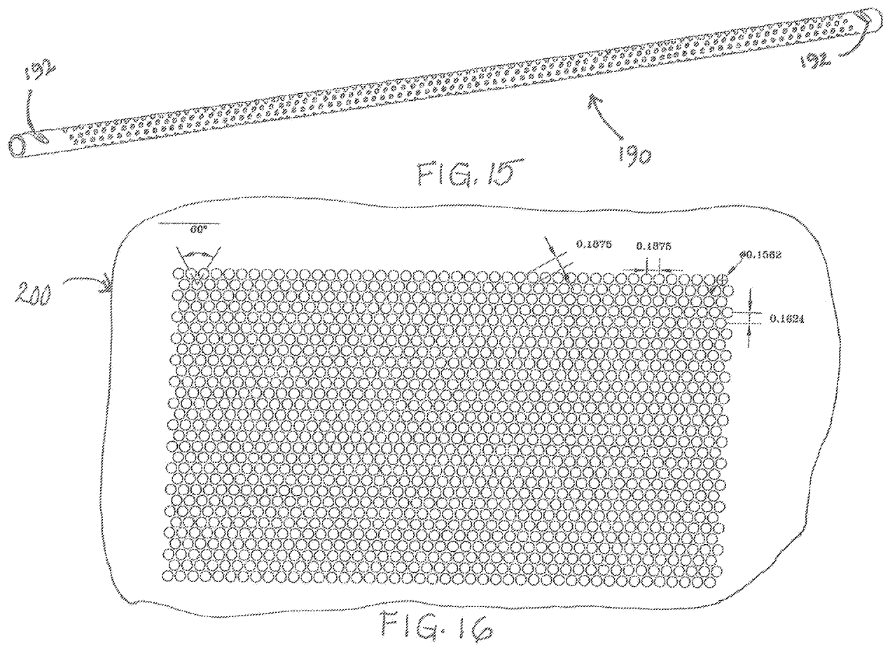

A bowl 230 containing specimens of a meat-based product having a spiral shape, unique texture, mouthfeel, flavor, and taste is shown in FIG. 17.

What has been described in this patent application is a system and a process for making shaped meat products. While the present subject matter has been described in relation to embodiments, it is not limited to them. On the contrary, since alternatives, changes, and/or modifications will become apparent after this application has been reviewed, all alternatives, changes, and modifications are to be viewed as being part of the present subject matter insofar as they fall within the spirit and scope of the appended claims.

I claim:

1. A system for preparing a shaped-meat product, comprising:
an oven (140A) defining a cooking region;
a rack (150) reciprocally movable along a first axis (X-X), for insertion into and retraction from the cooking region, wherein the rack (150) has opposite sides (160), each side including a plurality of shelf guides (170) spaced apart along a second axis (Y-Y) oriented transverse to the first axis;
a plurality of saddles (180) spaced apart along the first axis (X-X) on each of the plural shelf guides (170) of both sides (160) of the rack; and
a plurality of apertured tubes (190), wherein each tube (190) is dimensioned for enabling a plurality of meat strips to be spirally wrapped therearound, wherein each meat strip is about ¾ inches wide and about 14 inches long and about ¼ inches thick, wherein each of the plural tubes (190) is supported at its opposite ends by a spaced-apart pair of the plural saddles.

2. The system of claim 1, wherein each saddle (180) has an extension (182), and wherein each tube (190) includes a depression (192) at each end dimensioned and configured to mate with and engage the saddle extension (182), to securely retain each tube (190) to its spaced-apart saddles (180).

3. The system of claim 1, wherein each tube has an outside diameter of about 0.629 inches, a patterned hole size of about 5/32 inches, a distance between hole centers of about 3/16 inches, and an open area of about 63%.

4. The system of claim 3, wherein each tube is polished stainless steel.

5. The system of claim 1, wherein the oven can be heated for about 3 to about 4½ hours to a temperature ranging from about 135 to about 170° F.

6. A process for preparing a shaped-meat product, comprising:
preparing an ingredient mixture consisting essentially of about 1.1 wt.-% kosher salt, about 3.4 wt.-% turbinado cane sugar, about 0.6 wt.-% onion powder, about 2.2 wt.-% garlic powder, about 6.8 wt.-% molasses, about 22.7 wt.-% clover honey, about 3.4 wt.-% maple syrup, about 56.8 wt.-% teriyaki sauce, about 2.2 wt.-% balsamic vinegar, and about 0.4 wt.-% MSG;
immersing a plurality of meat strips in the mixture for about 44 hours at a temperature ranging from about 36 to about 40 degrees Fahrenheit (° F.) to produce a plurality of seasoned strips, wherein each of the plural meat strips is about ¾ inches wide and about 14 inches long and about ¼ inches thick;
spirally wrapping the plurality of seasoned strips around an associated plurality of apertured tubes (190), each tube having an outside diameter of about 0.629 inches, a patterned hole size of about 5/32 inches, a distance between hole centers of about 3/16 inches, and an open area of about 63%;
moving the plural apertured tubes (190) with seasoned strips helically or spirally wrapped therearound into a cooking region of an oven (140a); and
introducing into the cooking region a predetermined amount of heated air for about 3 to about 4½ hours at a temperature ranging from about 135 to about 170° F. for cooking and dehydrating the plural seasoned strips, for producing a plurality of meat products having an open-coiled spiral shape.
